(19) United States
(12) Patent Application Publication
(10) Pub. No.: US 2012/0226892 A1
(43) Pub. Date: Sep. 6, 2012

(54) Method and apparatus for generating efficient code for scout thread to prefetch data values for a main thread

(76) Inventors: Partha P. Tirumalai, Fremont, CA (US); Yonghong Song, South San Francisco, CA (US); Spiros Kalogeropulos, Los Gatos, CA (US)

(21) Appl. No.: 11/081,984

(22) Filed: Mar. 16, 2005

(51) Int. Cl. G06F 9/38; G06F 12/08

(52) U.S. Cl. 712/207; 712/E09.055

(57) ABSTRACT

One embodiment of the present invention provides a system that generates code for a scout thread to prefetch data values for a main thread. During operation, the system compiles source code for a program to produce executable code for the program. This compilation process involves performing reuse analysis to identify prefetch candidates which are likely to be touched during execution of the program. Additionally, this compilation process produces executable code for the scout thread which contains prefetch instructions to prefetch the identified prefetch candidates for the main thread. In this way, the scout thread can subsequently be executed in parallel with the main thread in advance of where the main thread is executing to prefetch data items for the main thread.

### BACKGROUND

1. Field of the Invention

The present invention relates to techniques for improving computer system performance. More specifically, the present invention relates to a method and an apparatus for generating code for a scout thread, which prefetches data values for a main thread.

2. Related Art

As the gap between processor performance and memory performance continues to grow, prefetching is becoming an increasingly important technique to improve application performance. Currently, prefetching is most effective for memory streams where future memory addresses can be easily predicted with the current loop index values. For such memory streams, software prefetching instructions are inserted into the machine code, to prefetch data values into cache before the data values are used. Such a prefetching scheme is also called interleaved prefetching.

Although it is successful for certain cases, the interleaved prefetching scheme tends to be less effective for two types of codes. The first type are codes with complex array subscripts, although with predictable patterns. Such complex subscripts often require more computation to compute the future addresses and hence incur more overhead for prefetching. If subscripts contain one or more other memory accesses, the overhead will become even larger since prefetching and speculative loads for these memory accesses are both necessary to form the base address of the prefetch candidate. One such example is indexed array accesses. If the prefetched data items are in the cache, such large overhead may rather cause significant execution time regression. To avoid such a potentially large penalty, for prefetch candidates with complex subscripts, modern production compilers often ignore them by default, or prefetch data speculatively one or two cache lines ahead.

The second type are pointer-chasing codes. For such memory streams, at least one memory address is needed to get the memory address in the next loop iteration. Interleaved prefetching is not able to handle such cases effectively. Several techniques have been proposed to handle such cases. The jump-pointer approach requires the whole program mode, which may not be available at compile time (see A. Roth and G. Sohi, Jump-pointer prefetching for linked data structures, Proceedings of the 26th International Symposium on Computer Architecture, May 1999).

Some researchers have tried to detect the regularity of the memory stream at compile time for Java applications (see Brendon Cahoon and Kathryn McKinley, “Data flow analysis for software prefetching linked data structures in Java,” Proceedings of the 2001 International Conference on Parallel Architectures and Compilation Techniques, 2001.)

Others have tried to detect the regularity of the memory stream with value profiling (see Youfeng Wu, “Efficient discovery of regular stride patterns in irregular programs and its use in compiler prefetching,” Proceedings of the International Conference on Programming Language Design and Implementation, June 2002.) This technique requires additional steps related to compilation and its accuracy depends on how close train and reference inputs match each other and how many predictable memory streams exist in the program.

Recently developed chip multi-threading (CMT) architectures with shared caches present new opportunities for prefetching. In CMT architectures, the other core (or logical processor) can be used to retrieve the data, which will be referenced in the main thread, into a shared cache.

“Software scout threading” is a technique which performs such prefetching in software. During software scout threading, a scout thread, which is created at runtime, executes in parallel with the main thread, and does not have any other programmer-visible side effects. The scout thread ties to prefetch data values that will be accessed by the main thread so that the data values are pulled into the shared cache. Since the scout thread does not perform any real computation (except for necessary computations to form prefetchable addresses and to maintain approximately correct control flow) the scout thread will typically execute faster that the main thread, which allows it to prefetch data values for the main thread. (For more details on scout threading, please refer to U.S. Pat. No. 6,415,356, entitled “Method and Apparatus for Using an Assist Processor to Pre-Fetch Data Values for a Primary Processor,” by inventors Shailender Chaudhry and Marc Tremblay.)

Software scout threading naturally handles the cases where interleaved prefetching is ineffective. For complex array subscripts, prefetching overhead is migrated to the scout thread. For pointer-chasing codes, software scout threading tries to speculatively load or prefetch what could be actually cache missing.

Unfortunately, software scout threading is not free. The process of launching the scout thread and operations involved in maintaining synchronization between the main thread and the scout thread can create overhead for the main thread. Such overhead must be considered by the compiler as well as the runtime system to determine whether scout threading is worthwhile. Furthermore, existing techniques for scout threading tend to generate redundant prefetches for cache lines that have already been prefetched. These redundant prefetches can degrade system performance during program execution.

Hence, what is needed is a method and an apparatus for reducing the impact of the above-described problems during software scout threading.

### SUMMARY

One embodiment of the present invention provides a system that generates code for a scout thread to prefetch data values for a main thread. During operation, the system compiles source code for a program to produce executable code for the program. This compilation process involves performing reuse analysis to identify prefetch candidates which are likely to be touched during execution of the program. Additionally, this compilation process produces executable code for the scout thread which contains prefetch instructions to prefetch the identified prefetch candidates for the main thread. In this way, the scout thread can subsequently be executed in parallel with the main thread in advance of where the main thread is executing to prefetch data items for the main thread.

In a variation on this embodiment, the reuse analysis identifies loads and stores which access the same cache line.

In a further variation, performing the reuse analysis to identify prefetch candidates involves using results of the reuse analysis to avoid redundant prefetches to the same cache line.

In a variation on this embodiment, prior to performing the reuse analysis, the compilation process involves building a loop tree hierarchy to represent a loop hierarchy of the program.

In a variation on this embodiment, producing the executable code for the scout thread involves transforming loads and stores into prefetches.

In a variation on this embodiment, producing the executable code for the scout thread involves producing executable code for the scout thread on a region-by-region basis, wherein a region of the program can include: a function body, a loop, a loop nest, or a block of code.

In a variation on this embodiment, producing the executable code for the scout thread involves, first determining profitability for scout threading on a region-by-region basis, and then producing executable code for the scout thread for a given region only if the determined profitability of the given region satisfies a pre-specified criterion.

In a further variation, determining the profitability for a given region involves considering: a startup cost for the scout thread for the given region; a predicted cache miss rate for the given region; and a cache miss penalty.

In a further variation, determining the profitability for a given region involves determining the benefit of scout threading for the given region based upon “savable” loads and stores, wherein savable loads and stores are loads and stores for which cache misses are likely to be avoided by scout threading.

In a variation on this embodiment, the executable code for the scout thread and the executable code for the main thread are integrated into the same executable code module.

### BRIEF DESCRIPTION OF THE FIGURES

FIG. 1A illustrates a processor system with a chip multi-threading (CMT) architecture in accordance with an embodiment of the present invention.

FIG. 1B illustrates how source code is compiled into a single executable code module, which can be executed by both a main thread and a scout thread in accordance with an embodiment of the present invention.

FIG. 1C presents a flow chart illustrating the compilation process in accordance with an embodiment of the present invention.

FIG. 2A illustrates a technique for a loop nest in accordance with an embodiment of the present invention.

FIG. 2B illustrates a technique for a loop nest in accordance with an embodiment of the present invention.

FIG. 3 illustrates a technique to select candidate loops for scout threading in accordance with an embodiment of the present invention.

FIG. 4 illustrates a technique to determine the profitability of a candidate loop for scout threading in accordance with an embodiment of the present invention.

FIG. 5A illustrates a technique to transform an original loop into a DOALL loop in accordance with an embodiment of the present invention.

FIG. 5B illustrates a technique to transform an original loop into a DOALL loop in accordance with an embodiment of the present invention.

FIG. 5C illustrates a technique to transform an original loop into a DOALL loop in accordance with an embodiment of the present invention.

FIG. 6 illustrates a technique to transform an software scout threading loop to a DOALL loop in accordance with an embodiment of the present invention.

FIG. 7A illustrates a first example in accordance with an embodiment of the present invention.

FIG. 7B illustrates a first example in accordance with an embodiment of the present invention.

FIG. 7C illustrates a first example in accordance with an embodiment of the present invention.

FIG. 7D illustrates a first example in accordance with an embodiment of the present invention.

FIG. 8A illustrates a second example in accordance with an embodiment of the present invention.

FIG. 8B illustrates a second example in accordance with an embodiment of the present invention.

FIG. 8C illustrates a second example in accordance with an embodiment of the present invention.

FIG. 8D illustrates a second example in accordance with an embodiment of the present invention.

FIG. 9A illustrates actions taken by the main thread to free shared data in parallel in accordance with an embodiment of the present invention.

FIG. 9B illustrates actions taken by the scout thread to free shared data in parallel in accordance with an embodiment of the present invention.

FIG. 10A illustrates the process of using scout threading for parallel applications in accordance with an embodiment of the present invention.

FIG. 10B illustrates the process of using scout threading for parallel applications in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices, such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as a LAN, a WAN, or the Internet.

### System

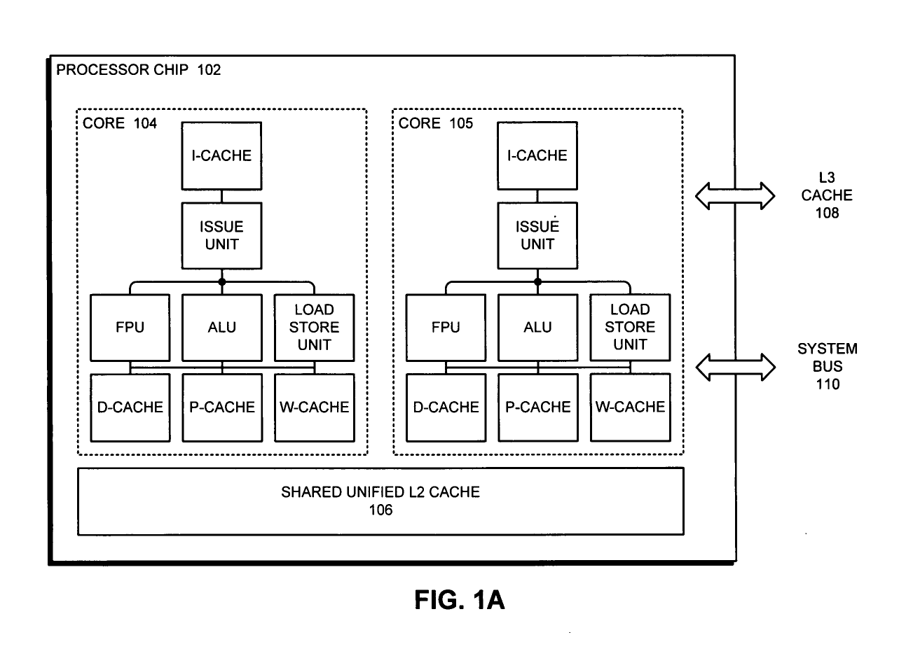

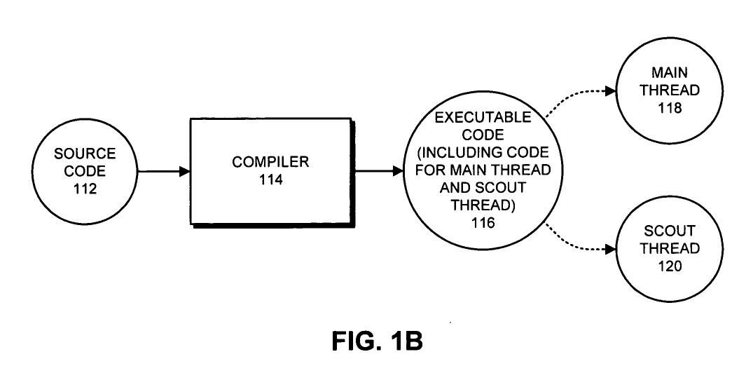

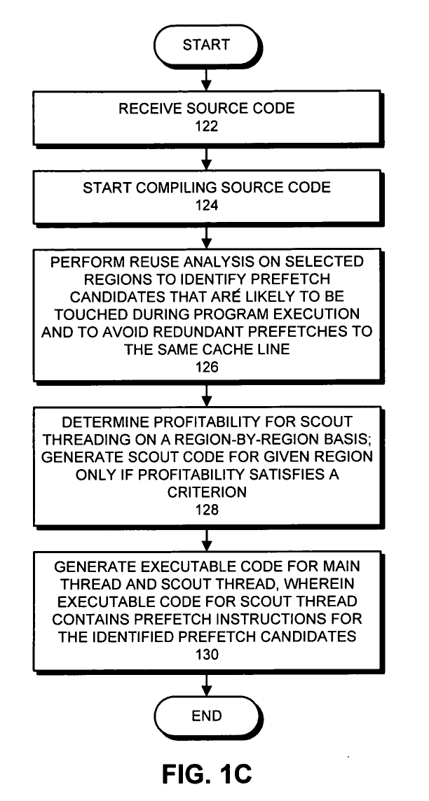

FIG. 1 illustrates a processor system with a chip multi-threading (CMT) architecture in accordance with an embodiment of the present invention. In this embodiment, processor chip 102 has two four-issue, in-order, superscalar cores 104-105. Each core 104-105 has its own first level instruction cache and data cache, both of which are 64 kB. Additionally, each core 104-105 also has its own instruction and data translation lookaside buffers (TLBs) (not shown). Cores 104-105 share an on-chip 2 MB level 2 (L2) unified cache 106, which has low latency and adequate bandwidth to support smooth dual core operation. Also shared is a large 32 MB off-chip dirty-victim level 3 (L3) cache 108. L2 cache 106 and L3 cache 108 can be configured to be in split or shared mode. In split mode, each core can allocate only in half the cache. However, each core can read all of the cache. In shared mode, each core can allocate in all of the cache.

One embodiment of the present invention supports nine variations of software prefetching. These variations include: read once, read many, write once, and write many. Each of these four variations can be either weak or strong. Weak prefetches are dropped if a TLB miss occurs during prefetch address translation. On the other hand, strong prefetches will generate a TLB trap and the prefetch will be processed (after the trap). An instruction prefetch is also provided to prefetch instructions. A control bit in the processor further controls the behavior of weak prefetches. These weak prefetches can be dropped if the 8-entry prefetch queue is full, or the processor stalls until a queue slot is available. Latencies to L1 and L2 are 2-3 clocks and 15-16 clocks, respectively.

One embodiment of the present invention allows the main or compute thread to use all prefetch variants. Program analysis and compiler options determine the variants used for prefetchable accesses. Unless otherwise mentioned, the scout thread uses only strong prefetch variants. This is so because the scout thread is expected to run ahead but not do any (unsafe) loads or stores. If prefetches were dropped on a TLB miss, the benefit of scout threading would be lost or vastly diminished. One embodiment of the present invention also has a prefetch control setting to disallow dropping of weak prefetches if the prefetch queue is full.

### Compilation Process

FIG. 1B illustrates how source code 112 is compiled into executable code 116 in accordance with an embodiment of the present invention. In this embodiment, compiler 114 compiles source code 112 into a single executable code module 116, which includes code for both main thread 118 and scout thread 120. This single executable code module 116 can then be executed by both a main thread 118 and a scout thread 120 (as is illustrated by the dashed arrows in FIG. 1B).

FIG. 1C presents a flow chart illustrating the compilation process in accordance with an embodiment of the present invention. During this compilation process, the system first receives source code 112 for a program (step 122) and starts compiling source code 112 (step 124).

During this compilation process, the system performs “reuse analysis” on selected regions to identify prefetch candidates that are likely to be touched during program execution. This reuse analysis is also used to avoid redundant prefetches to the same cache line (step 126). (Reuse analysis is further described in a paper entitled, “Processor Aware Anticipatory Prefetching in Loops,” by S. Kalogeropulos, M. Rajagopalan, V. Rao, Y. Song and P. Tirumalai, 10^{th} Int'l Symposium on High Performance Computer Architecture (HPCA '04).)

Next, the system determines the profitability for scout threading for the program on a region-by-region basis. The system then generates scout code for a given region if the profitability for the given region satisfies a profitability criterion (step 128).

Finally, the system generates executable code for the main thread and the scout thread, wherein the executable code for the scout thread includes prefetch instructions for the identified prefetch candidates (step 130). This compilation process is described in more detail below.

### Compiler Support for Software Scout Threading

To perform software scout threading, the compiler needs to analyze the program and decide:
which loops should be software scout threading candidates, and which loads and stores should be software scouted inside these loops;
how to determine the profitability; and
how the final codes are generated.

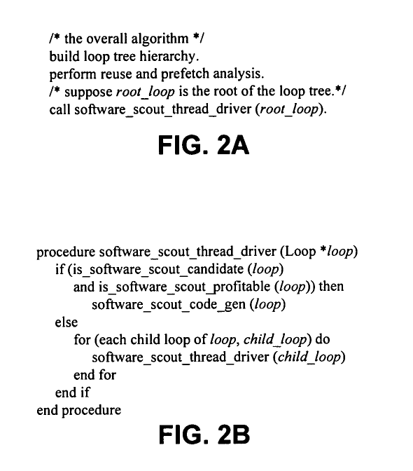

FIG. 2A shows the overall technique. Since the current software scout threading work is based on loops, a loop hierarchy tree is first built to represent the loop hierarchy of the program. The reuse analysis and prefetch candidate identification analysis are then performed to identify the prefetch candidates. The analysis result will be later used to avoid redundant prefetches. Suppose the root of the loop tree is root_loop, the compiler calls software_scout_thread_driver (root_loop) (which is shown in FIG. 2B) to perform software scout threading detection and transformation. For each loop in the loop hierarchy, if the compiler decides that loop is a candidate of software scout threading (function is_software_scout_candidate) and it is profitable for software scout threading (function is_software_scout_profitable), its children will not be processed further. The function is_software_scout_candidate also decides which loads and stores in the loop body should be turned into prefetches. For a software scout threading candidate, appropriate codes will be generated with function software_scout_code_gen.

A few practical issues need to be addressed in code generation due to dynamic nature of operating system scheduling, even with processor binding. Particularly, we need to consider in code generation: (1) how to prevent scout thread from running behind main thread too much; and (2) how to minimize performance loss in single-threaded execution mode. To address these issues, a possible idea for our code generation scheme is to check whether the main thread has done or not before executing the scout thread (for the above issue (2)) and to check periodically in the scout thread whether the main thread has done or not (for the above issue (1)). Furthermost, prefetch instructions are still inserted into the main thread as in the single-threaded execution mode. In this disclosure, we describe how software scout threading candidate loops are selected, how profitability for candidate loops is determined, and how the corresponding code is transformed to facilitate scout threading.

### Selecting Candidate Loops

The benefit of software scout threading comes from two sources. First, the scout thread has potentially less computation than the main thread, thus may potentially execute certain loads earlier to bring the value to the shared L2 cache. Second, certain loads and stores, where the load values are not used in scout thread, can be transformed into prefetches directly, which represents a net saving for the scout thread. If the application is memory-bound, the first potential benefit will be less because the loads in both main and scout thread present the critical path for the application. One of our schemes selects the candidate loops mainly based on the second potential benefit.

A load or store is defined as a savable memory access if the loaded value is not used in another address computation or branch condition, directly or indirectly, and the following conditions meet:
the address computation of the load or store depends on at least another load, directly or indirectly, in the same loop body; or
otherwise, this load or store has been determined as a prefetch candidate through previous reuse and prefetch analysis.

In order to determine whether a load or store is savable, its address computation will be examined based on define-use data flow chain. If for any assignment in the same loop body, its defined variable appears in the address computation, the right-hand side computation of that assignment will be considered as part of the original address computation and will be examined recursively.

Here, for the define-use data flow chain, we only consider definitions which are assignments to a variable. For any variable use, if one of its definitions is not an assignment, that definition will be ignored. The compiler also ignores all data flow uses, derived from indirect memory accesses by memory loads, and their definition-use chains. Although this might cause the computed final prefetch address to be incorrect, since the scout thread is constructed not to cause any exception and to periodically check whether the main thread is done to determine whether it should finish early, such an ignorance can greatly help compiler work around alias issues and broaden the ability to software scout thread loops in pointer-intensive programs.

The scout thread is a reduced version of the main thread and it will approximate the original program's control flow. (Note that a system of periodic checks ensures that the scout thread will not continue off in a wrong direction while the main thread has finished a code section and has moved on.) The compiler also examines all the branch conditions in the loop body. It will also trace define-use chain for any assignment whose defined variable appears in one of branch conditions. Similar to defining address computation of a load or store, the right-hand side computation of that assignment is also considered as part of the branch condition and will be examined recursively. All such computation will be kept in the scout thread.

Because of limited size of the shared L2 cache, there is a possibility that the scout thread may run too far ahead and rather overwrite the useful data used in the main thread. To prevent such a scenario, the compiler does two checks. First, if the loop body contains any function calls, the loop will not be considered as a candidate, since function calls may cause side effects in the scout thread and it might be hard for the compiler to analyze the potential execution time for function calls. Second, the compiler analyzes whether the loop is computation bound or memory bound. If the loop is computation bound, which means that there is enough computation to hide memory latency, the loop will not be considered as a candidate. To compute whether the loop is computation or memory bound, the compiler estimates total execution time for computation and also for memory accesses with an assumed miss rate. If the computation takes more time than memory accesses, it is computation bound. Otherwise, it is memory bound.

Eventually, the scout thread will turn savable loads or stores to prefetches, and keep only computations which either contribute to the savable load/store address computation or to the branch resolution. All the loads in the scout thread will turn into non-faulting loads. In order to make scout thread hardware exception free, if any floating-point computation will finally be left in the scout thread, the corresponding loop will not be software scouted.

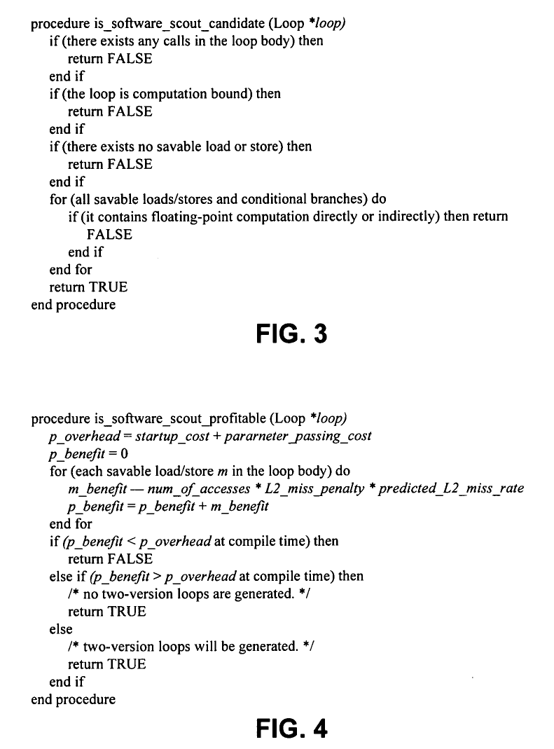

FIG. 3 shows the technique to decide whether a loop is a software scout threading candidate. A candidate loop must have at least one savable load or store, and its savable loads/stores and conditionals must not contain floating-point computation to avoid potential exception. The candidate loop should not contain any function calls and must be memory bound.

### Determining Profitability of Candidate Loops

Software scout threading utilizes the existing automatic parallelization infrastructure which uses a fork-join model. The parallelizable loop will be outlined and a runtime library is called to control dispatching the threads, synchronization, etc. Parallelization involves overhead in the runtime library and also parameter passing due to outlining. The benefit of software scout threading comes from the potential cache hit in the main thread for some memory accesses which may otherwise be cache miss in a single-thread run. The compiler will analyze the potential software scout threading benefit vs. parallelization overhead to either decide a loop as profitable/non-profitable at compile time, or generate two version loops with a runtime test for profitability. If the compiler decides a loop non-profitable at compile time, that loop will be rejected for software scout threading.

FIG. 4 shows the technique to determine the profitability. The overhead of parallelization is computed as the runtime library cost startup_cost and the cost of passing various shared and first/last private variables parameter_passing_cost. The startup_cost is a fixed empirical value and the parameter_passing_cost is the cost of passing the value for one variable, which is also a fixed empirical value, multiplied by the number of variables.

In order to compute the benefit of the software scout threading, the compiler focuses on savable loads and stores. Although it is possible that other non-savable loads may change from cache misses in the single-thread run to cache hits in the scout threading scheme, savable loads and stores should represent most noticeable potential with software scout threading. For each savable load or store, the potential saving, m_benefit, is computed as the total number of accesses of this load/store in one invocation of this loop num_of_accesses, multiplied by the L2 cache miss penalty L2_miss_penalty, multiplied by the potential L2 miss rate for this memory access potential_L2_miss_rate. The L2_miss_penalty is a fixed value given a specific architecture. To compute potential_L2_miss_rate, the address computation of this load or store is analyzed. If the address computation contains another load directly, we assume a high potential L2 miss rate. Otherwise, if the address computation contains another load indirectly, we assume a middle potential L2 miss rate. Otherwise, if the address computation does not contain any other load directly or indirectly, we assume a lower potential L2 miss rate. The specified values of potential_L2_miss_rate are determined experimentally. We could have better values if the cache profiling is available.

The values for potential_L2_miss_rate also depend on whether the main thread does prefetching or not. If the main thread also does prefetching, their values tend to be lower compared to no prefetching in the main thread. For a particular access, it also depends on how good the main thread prefetching is for that memory access. In one embodiment of the present invention, we attribute different potential_L2_miss_rates to different savable loads and stores based on how complex the address computation is, since the complexness of the address computation directly affects compiler's ability for effective prefetching. For example, a savable load with simple linear array subscript of the enclosing loop indices will have lower potential_L2_miss_rate compared to that with a complex array subscript which involves division and modulo operations on the loop index variables.

The compiler needs to compute the number of accesses for a particular savable load or store, num_of_accesses. If the profile feedback information is available, the compiler computes num_of_accesses as the total access numbers of the load or store divided by the number of access times for the loop itself. If the loop is not accessed based on profile data, we set num_of_accesses to be 0.

If the profile feedback information is not available, the compiler needs to compute num_of_accesses heuristically. Particularly, it needs to determine trip counts for loops surrounding that load/store. If the actual trip count is known at compile time, the compiler will use that value. Otherwise, if the profile feedback information is available, the compiler will try to compute an average trip count (across all invocations) for that loop. If profile feedback information is not available, the compiler will examine whether it can compute the trip count symbolically through some loop invariants. If it can, the compiler will use that expression to represent the trip count. Otherwise, the compiler will assume a trip count for that particular loop. In our framework, a trip count of 25 is assumed for any loop which the compiler cannot determine or compute the trip count at the compile time. With such an assumption, the compiler avoids potential regression for C/C++ applications that many loops are uncountable while loops. Our compiler also considers branches which are not loop back edges during the computation of num_of_accesses. If the profile feedback information is available, the branch taken probability will be computed based on that information. Otherwise, the compiler will assume equal probability for if taken/non-taken targets or all case targets of a switch statement. The total number of accesses, num_of_accesses, will be computed based on trip counts and assigned branch probability information.

The total benefit of the software scout threading, p_benefit, is the summation of the benefit of all savable loads and stores. If at compile time, p_benefit is no greater than p_overhead, this loop will not be software scouted. Otherwise, if at compile time, p_benefit is greater than p_overhead, this loop will be software scouted without two versioning. Otherwise, the loop will be two-versioned with a condition p_benefit>p_overhead. At runtime, if the condition is true, the software scouted version will be executed. Otherwise, the original serial version will be executed.

### Code Generation

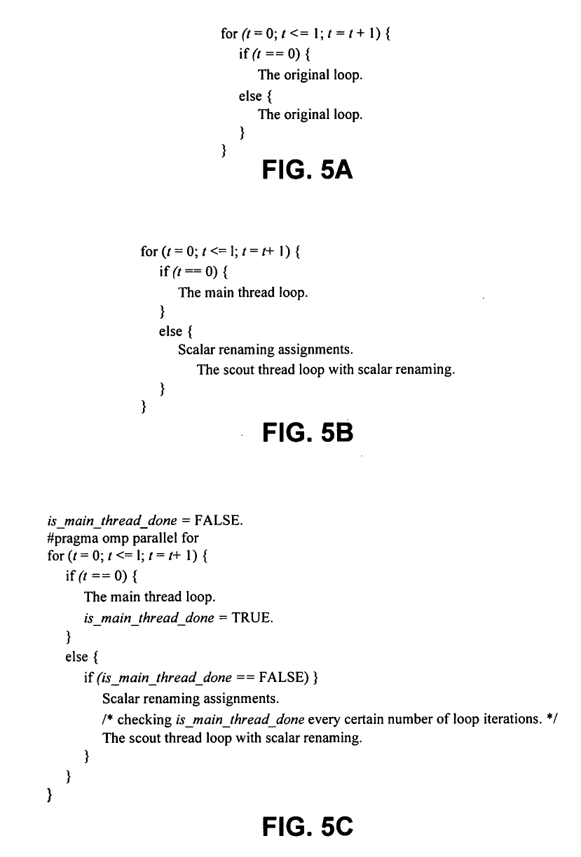

Given an original loop, the compiler transforms it for software scout threading with three steps. In the first step, the compiler generates the code like FIG. 5A. The runtime library has been modified to guarantee that the main thread will execute the branch if t==0 is true, and the scout thread will execute the other branch, if the loop t is parallelized and two threads are available. This is to minimize the overhead for the main thread to avoid the main thread slowdown. The scout thread will incur potential overhead to warm up its L1 cache and the TLB. The else branch loop in FIG. 5A will be transformed to form a scout thread loop.

In the second step, a proper scout thread loop will be generated through program slicing and variable renaming. The scout thread loop is a sliced original loop in the sense that only original control flow and prefetches to the savable loads or stores, as well as necessary computation to compute the addresses and conditionals, are left. The savable loads or stores are transformed to strong prefetches. All the loads in the scout thread become non-faulting loads to avoid exceptions on the scout thread. Because there may have assignments in the scout thread, the compiler renames all those upward-exposed or downward-exposed assigned variables in the scout thread and copy the original values of these renamed variables to their corresponding temporary variables right before the scout thread loop. In one embodiment of the present invention, all scalar variables are scoped as private variables including first private, last private or both, so that these temporary variables will get correct values at runtime. FIG. 5B shows the code after program slicing and variable renaming.

In practice, it is possible that scout thread could run behind the main thread. If this happens, the scout thread should finish early to avoid performing useless work. In the last step, the compiler inserts codes right after the main thread loop to indicate that the main thread loop is done. It also inserts codes to check whether the main thread loop is done or not before executing the scout thread loop. It also inserts code to check whether the main thread is done or not every certain number of all loop iterations, including the scout thread loop and all its inner loops. This can be done by adding checking at every loop back edge, which will be illustrated later in detail through examples. If any checking reveals that the main thread has done, the scout thread will stop its job immediately. FIG. 5C shows the transformed code. The loop t in FIG. 5C is marked as a DO ALL loop and will be later parallelized with the existing automatic parallelization framework.

### Variable Scoping

For the parallel loop t, the compiler scopes the variables based on the following rules:
All arrays and address-taken scalars are shared.
All non-address-taken scalars (including structure members) are private.
Any scalars upward-exposed to the beginning of loop t are first private.
Any scalars downward-exposed to the end of loop t are both last private and first private. The purpose is to copy out correct value in case that the scalar assignment statement does not execute at runtime.

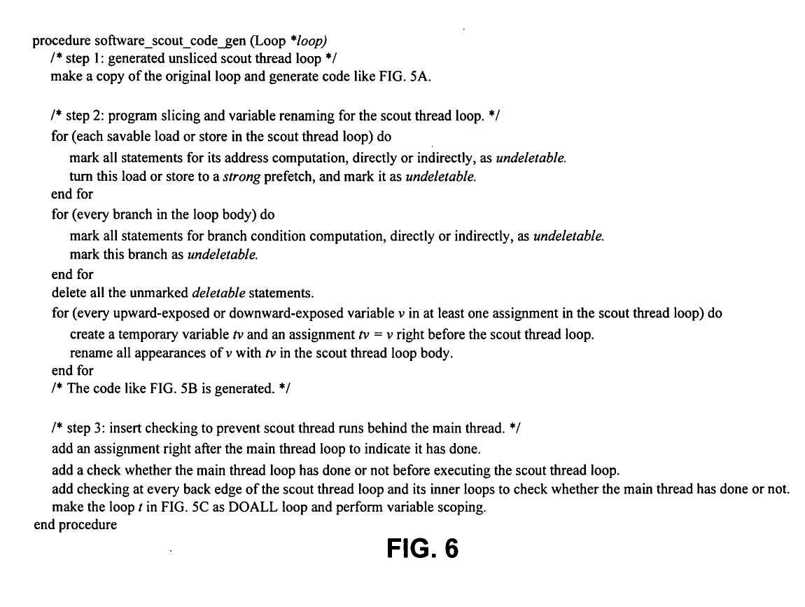

For any downward exposed variables, the runtime library and outlining code generation have been modified to copy out the downward exposed variables in the main thread since all the original computation is done in the main thread. FIG. 6 shows the compiler technique to transform a software scout threading loop candidate to a DO ALL loop.

### EXAMPLES

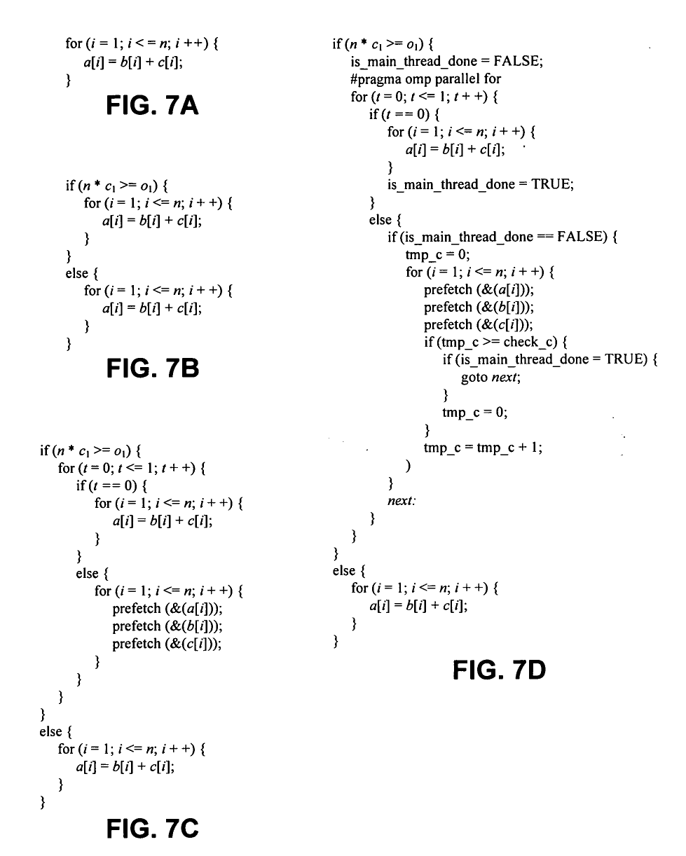

FIG. 7A shows Example 1 whose trip count, though unknown, can be computed at compile time. FIG. 7B shows codes after two-version parallelization transformation. The o₁ here represents the parallelization overhead. The potential benefit of software scout threading is computed as n*c₁ where c₁ is a compile-time constant. FIG. 7C shows codes after program slicing and variable renaming. FIG. 7D shows codes after checking codes are added to end scout thread earlier if it runs behind the main thread. The variable tmp_c is used to count the number of iterations in the scout thread. The variable check_c, which is a compile-time constant, specifies the number of iterations to check whether the main thread has finished or not.

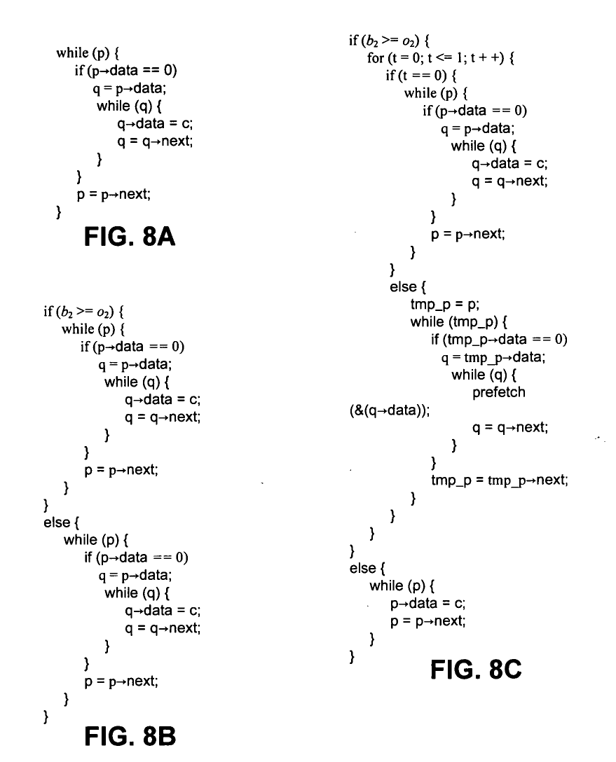

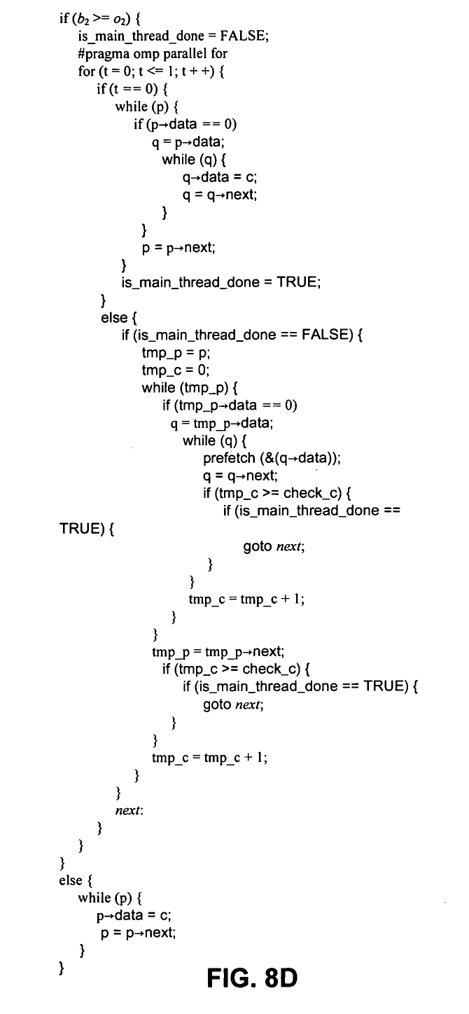

FIG. 8A shows a more complex example, Example 2, whose trip counts cannot be computed at compile time. We also assume that the compiler is not able to guarantee that q→data and p→next access different memory locations at compile time. If profile feedback data is available, the compiler will compute the trip count and branch probabilities based on profile data. Otherwise, the compiler chooses default values for unknown trip counts and branch probabilities (as described above).

FIG. 8B shows codes after two-version parallelization transformation. The b₂ is the potential benefit for the software scout threading and o₂ is the parallelization overhead. Both are compile-time constants. Therefore, at compile time, the branch will be resolved. FIG. 8C shows codes after scout thread program slicing and variable renaming. Note that the variable tmp_p is used to copy the original p value.

FIG. 8D shows codes after checking codes are added to end scout thread earlier in case that the scout thread runs behind the main thread. Note that all back edges in the scout thread loop or its inner loops are checked. This is necessary in case that the innermost loop is never or rarely got executed.

### Runtime Support for Software Scout Threading

In FIG. 5C, the compiler creates a parallel loop t which will spawn the main thread and the scout thread at runtime. Software scout threading shares the same runtime as other automatic/explicit parallelization.

For each loop parallelized with software scout threading, runtime creates one POSIX thread to represent the scout thread. This POSIX thread will be reused as the scout thread for subsequent software scout threading loops.

For automatic/explicit parallelization, there often exists a synchronization instruction at the end of parallel region. Such a synchronization instruction, however, may unnecessarily cause slowdown of the main thread for software scout threading. Hence, we do not want synchronization at the end of parallel for loop t. Currently, some data (like loop bounds, first private data and shared data, etc.) are passed from the serial portion of the main thread to the runtime library, and then to the outlined routine, which will be executed by both the main thread and the scout thread. Such data, which we call shared parallel data, will be allocated on the heap through the C programming language malloc( ) routine. The runtime system must find a way to free such space to avoid potential out-of-memory issues.

The main thread will access every piece of shared parallel data. But the scout thread may not, since it may be suspended or just run too slow and skip some parallel regions. Also, for every piece of shared data, the main thread will access it first before the scout thread accesses it, since the main thread activates the scout thread.

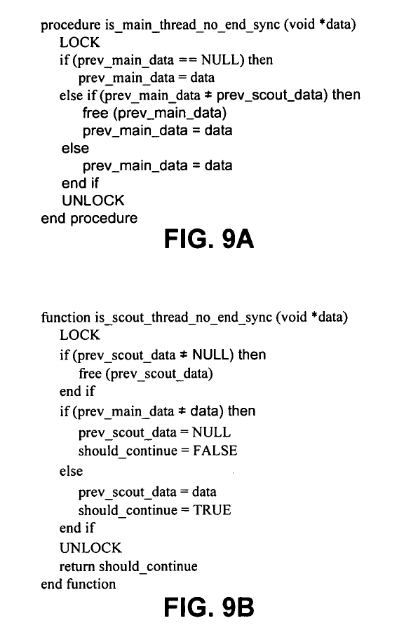

FIGS. 9A and 9B show the actions taken by the main thread and the scout thread respectively, in order to free shared parallel data. The function parameter is the address of the shared parallel data for the current parallel region. The functions are called in the beginning of the main thread and the scout thread inside the runtime library, respectively, before delivering control to the outlined routine. The global variables prev_main_data and prev_scout_data are used to record the previously accessed shared parallel data by the main thread and the scout thread respectively, both of which have an initial NULL value. Note that for the scout thread, if its to-be-processed shared parallel data are not the one currently accessed by the main thread, the scout thread should not continue the stale parallel region, which is indicated by the return value should-continue. Since both functions access the shared data, to avoid race condition, the same LOCK/UNLOCK pair is placed in the beginning and the end of both functions.

### 2. Discussion

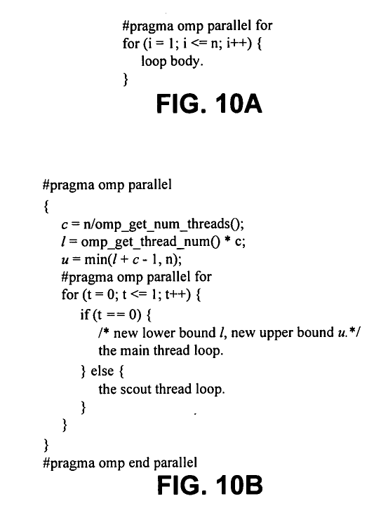

One embodiment of the present invention improves performance of single-threaded application on a single-chip system. In a multiprocessor system constructed with chips (such as the UltraSPARC™ IV+), if the scalability for an already parallelized program is not good, the extra cores might be used for scout threading. FIGS. 10A-10D illustrate such an example. FIG. 10A shows an original parallel loop, assuming static scheduling. FIG. 10B shows the transformed code, which utilizes the nested parallel region. For simplicity, the codes to check whether the main thread is done or not are omitted in FIG. 10B. If the application scalability is good, the inner parallel region can just have one thread. Otherwise, the inner parallel region can have two threads to utilize the software scout threading.

Some of the latest generation microprocessor chips only support two cores in the same chip. The ongoing trend indicates that future chips will contain more than two cores in a single chip die, and each core will support more than one hardware thread context at the same time. In order to improve single-threaded application on these new chips, software scout threading technique can be extended to create multiple scout threads in parallel. If the scout thread loop is countable at compile time, the compiler can apply static scheduling with certain chunk size for the scout thread loop in order to utilize all available cores or hardware threads. Otherwise, the compiler might need to have a backbone scout thread and dynamically generate other scout threads.

In one embodiment of the present invention, we use environment variable for processor binding in order to ensure that the scout thread and the main thread are running on different cores of the same chip. This is very inconvenient and also makes software scout threading very difficult to use together with automatic parallelization. The best thing for users is just one flag to indicate intention of software scout threading, and the compiler and runtime library will work together to ensure proper scheduling. This requires certain low overhead operating system support such as to get the key hardware characteristics like shared cache and logical processor hierarchy, to be able to bind to a set of logical processors if the chip contains more than two logical processors, and to accurately predict the machine load, etc.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for generating code for a scout thread to prefetch data values for a main thread, comprising:
receiving source code for a program; and
compiling the source code to produce executable code for the program by:
performing reuse analysis to identify prefetch candidates which are likely to be touched during execution of the program;
conditionally replacing loads and stores from the prefetch candidates with prefetch instructions for the scout thread; and
producing executable code for the scout thread which contains prefetch instructions to prefetch the identified prefetch candidates for the main thread, wherein when executed, a prefetch instruction prefetches a data item from a main memory to a cache memory for the corresponding replaced load or store before the data item is used by the main thread as the main thread executes the corresponding load or store;
whereby the scout thread can subsequently be executed in parallel with the main thread and separately from the main thread in advance of where the main thread is executing.

2. The method of claim 1, wherein the reuse analysis identifies loads and stores which access the same cache line.

3. The method of claim 2, wherein performing the reuse analysis to identify prefetch candidates involves using results of the reuse analysis to avoid redundant prefetches to the same cache line.

4. The method of claim 1, wherein prior to performing the reuse analysis, the compilation process involves building a loop tree hierarchy to represent a loop hierarchy of the program.

5. (canceled)

6. The method of claim 1, wherein producing the executable code for the scout thread involves producing executable code for the scout thread on a region-by-region basis, wherein a region of the program can include:
a function body;
a loop;
a loop nest; or
a block of code.

7. The method of claim 1, wherein producing the executable code for the scout thread involves, first determining profitability for scout threading on a region-by-region basis, and then producing executable code for the scout thread for a given region only if the determined profitability of the given region satisfies a pre-specified criterion.

8. The method of claim 7, wherein determining the profitability for a given region involves considering:
a startup cost for the scout thread for the given region;
a predicted cache miss rate for the given region; and
a cache miss penalty.

9. The method of claim 7, wherein determining the profitability for a given region involves determining the benefit of scout threading for the given region based upon “savable” loads and stores, wherein savable loads and stores are loads and stores for which cache misses are likely to be avoided by scout threading.

10. The method of claim 1, wherein the executable code for the scout thread and the executable code for the main thread are integrated into the same executable code module.

11. A computer-readable storage medium storing instructions that when executed by a computer cause the computer to perform a method for generating code for a scout thread to prefetch data values for a main thread, the method comprising:
receiving source code for a program; and
compiling the source code to produce executable code for the program by:
performing reuse analysis to identify prefetch candidates which are likely to be touched during execution of the program;
conditionally replacing loads and stores from the prefetch candidates with prefetch instructions for the scout thread; and
producing executable code for the scout thread which contains prefetch instructions to prefetch the identified prefetch candidates for the main thread, wherein when executed, a prefetch instruction prefetches a data item from a main memory to a cache memory for the corresponding replaced load or store before the data item is used by the main thread as the main thread executes the corresponding load or store;
whereby the scout thread can subsequently be executed in parallel with the main thread and separately from the main thread in advance of where the main thread is executing.

12. The computer-readable storage medium of claim 11, wherein the reuse analysis identifies loads and stores which access the same cache line.

13. The computer-readable storage medium of claim 12, wherein performing the reuse analysis to identify prefetch candidates involves using results of the reuse analysis to avoid redundant prefetches to the same cache line.

14. The computer-readable storage medium of claim 11, wherein prior to performing the reuse analysis, the compilation process involves building a loop tree hierarchy to represent a loop hierarchy of the program.

15. (canceled)

16. The computer-readable storage medium of claim 11, wherein producing the executable code for the scout thread involves producing executable code for the scout thread on a region-by-region basis, wherein a region of the program can include:
a function body;
a loop;
a loop nest; or
a block of code.

17. The computer-readable storage medium of claim 11, wherein producing the executable code for the scout thread involves, first determining profitability for scout threading on a region-by-region basis, and then producing executable code for the scout thread for a given region only if the determined profitability of the given region satisfies a pre-specified criterion.

18. The computer-readable storage medium of claim 17, wherein determining the profitability for a given region involves considering:
a startup cost for the scout thread for the given region;
a predicted cache miss rate for the given region; and
a cache miss penalty.

19. The computer-readable storage medium of claim 17, wherein determining the profitability for a given region involves determining the benefit of scout threading for the given region based upon “savable” loads and stores, wherein savable loads and stores are loads and stores for which cache misses are likely to be avoided by scout threading.

20. The computer-readable storage medium of claim 11, wherein the executable code for the scout thread and the executable code for the main thread are integrated into the same executable code module.

21. An apparatus that generates code for a scout thread to prefetch data values for a main thread, comprising:
a processor;
a main memory;
a cache memory; and
a compilation mechanism configured to compile source code for a program to produce executable code for the program, wherein the compilation mechanism is configured to:
receive source code for a program;
perform reuse analysis to identify prefetch candidates which are likely to be touched during execution of the program;
conditionally replace loads and stores from the prefetch candidates with prefetch instructions for the scout thread; and
produce executable code for the scout thread which contains prefetch instructions to prefetch the identified prefetch candidates for the main thread, wherein when executed, a prefetch instruction prefetches a data item from a main memory to a cache memory for the corresponding replaced load or store before the data item is used by the main thread as the main thread executes the corresponding load or store;
whereby the scout thread can subsequently be executed in parallel with the main thread and separately from the main thread in advance of where the main thread is executing.
